(19) United States
(12) Patent Application Publication
(10) Pub. No.: US 2025/0103695 A1
(43) Pub. Date: Mar. 27, 2025

(54) TRACKING BIOMETRIC DATA IN RESPONSE TO DEVICE MOVEMENT

(71) Applicant: Apple Inc., Cupertino, CA (US)

(72) Inventors: Ioana NEGOITA, Mountain View, CA (US); Ian PERRY, San Jose, CA (US); Timothy PSIAKI, Redmond, WA (US); David LOEWENTHAL, Seattle, WA (US); Trent A. GREENE, Santa Clara, CA (US); Brian W. TEMPLE, Santa Clara, CA (US)

(21) Appl. No.: 18/890,067

(22) Filed: Sep. 19, 2024

Related U.S. Application Data
(60) Provisional application No. 63/680,933, filed on Aug. 8, 2024.
(60) Provisional application No. 63/584,796, filed on Sep. 22, 2023.

(51) Int. Cl. G06F 21/32; G06V 40/18

(52) U.S. Cl. CPC G06F 21/32; G06V 40/197

(57) ABSTRACT

This relates generally to systems and methods for tracking and recording pupil dilation and/or signs of unconsciousness in response to detecting specific movements of the electronic device. In some examples, the electronic device captures and tracks first biometric data including pupil dilation using one or more input devices. In some examples, in response to detecting a movement of the electronic device, such as a rapid acceleration or deceleration of the electronic device, the electronic device captures second biometric data. In some examples, the electronic device displays a virtual object while presenting an extended reality environment, such as a visual indication in response to detecting that the second biometric data meets one or more criteria based on a comparison of the second biometric data with the first biometric data. In some examples, the electronic device initiates an emergency response based on the second biometric data.

### CROSS-REFERENCE TO RELATED APPLICATIONS

This application claims the benefit of U.S. Provisional Application No. 63/680,933, filed Aug. 8, 2024, and U.S. Provisional Application No. 63/584,796, filed Sep. 22, 2023, the contents of which are herein incorporated by reference in their entireties for all purposes.

### FIELD OF THE DISCLOSURE

This relates generally to systems and methods for tracking biometric data in response to detecting a movement of an electronic device, and more particularly to tracking and recording pupil dilation and/or signs of unconsciousness in response to detecting specific movements of the electronic device.

### BACKGROUND OF THE DISCLOSURE

Some computer graphical environments provide two-dimensional and/or three-dimensional environments where at least some objects displayed for a user's viewing are virtual and generated by a computer. In some examples, an electronic device passively captures biometric data while the user is using the electronic device. Because biometric data is unique to each user, there is a need for systems and methods for tracking biometric data.

### SUMMARY OF THE DISCLOSURE

This relates generally to systems and methods of tracking biometric data in response to detecting a movement of the electronic device, and more particularly to tracking and recording pupil dilation and/or signs of unconsciousness in response to detecting specific movements of the electronic device. In some examples, the electronic device captures and tracks first biometric data including pupil dilation using one or more input devices. In some examples, in response to detecting a movement of the electronic device, such as a rapid acceleration or deceleration of the electronic device, the electronic device captures second biometric data. In some examples, the electronic device displays a virtual object while presenting an extended reality environment, such as a visual indication in response to detecting that the second biometric data meets one or more criteria based on a comparison of the second biometric data with the first biometric data. In some examples, the electronic device initiates an emergency response based on the second biometric data. In some examples, presenting the extended reality environment at an electronic device includes presenting pass-through video of the physical environment of the electronic device. As described herein, for example, presenting pass-through video can include displaying virtual or video passthrough in which the electronic device uses a display to present images of the physical environment and/or presenting true or real passthrough in which portions of the physical environment are visible to the user through a transparent portion of the display.

The full descriptions of these examples are provided in the Drawings and the Detailed Description, and it is understood that this Summary does not limit the scope of the disclosure in any way.

### BRIEF DESCRIPTION OF THE DRAWINGS

FIG. 1 illustrates an electronic device presenting an extended reality environment according to some examples of the disclosure.

FIG. 2 illustrates a block diagram of an example architecture for a device according to some examples of the disclosure.

FIG. 3 illustrates a flow chart of an example process of an electronic device recording biometric data and displaying an indication in response to detecting a movement of the electronic device according to some examples of the disclosure.

FIGS. 4A-4B illustrate example recordings of pupil dilation during different light conditions according to some examples of the disclosure.

FIGS. 5A-5B illustrate an example of a movement of an electronic device that satisfies the one or more first criteria according to some examples of the disclosure.

FIGS. 6A-6C illustrate examples of the second biometric data compared to the baseline biometric data and the resulting presentation on the electronic device according to some examples of the disclosure.

FIGS. 7A-7E illustrate examples of the second biometric data and the resulting actions on the electronic device according to some examples of the disclosure.

FIG. 8 illustrates a flow chart of an example process of an electronic device recording biometric data and initiating an emergency response in response to detecting a movement of the electronic device according to some examples of the disclosure.

### DETAILED DESCRIPTION

This relates generally to systems and methods of tracking biometric data in response to detecting a movement of the electronic device, and more particularly to tracking and recording pupil dilation and/or signs of unconsciousness in response to detecting specific movements of the electronic device. In some examples, the electronic device captures and tracks first biometric data including pupil dilation using one or more input devices. In some examples, in response to detecting a movement of the electronic device, such as a rapid acceleration or deceleration of the electronic device, the electronic device captures second biometric data. In some examples, the electronic device displays a virtual object while presenting an extended reality environment, such as a visual indication in response to detecting that the second biometric data meets one or more criteria based on a comparison of the second biometric data with the first biometric data. In some examples, the electronic device initiates an emergency response based on the second biometric data. In some examples, presenting the extended reality environment at an electronic device includes presenting pass-through video of the physical environment of the electronic device. As described herein, for example, presenting pass-through video can include displaying virtual or video passthrough in which the electronic device uses a display to present images of the physical environment and/or presenting true or real passthrough in which portions of the physical environment are visible to the user through a transparent portion of the display.

In some examples, a three-dimensional object is displayed in a computer-generated three-dimensional environment with a particular orientation that controls one or more behaviors of the three-dimensional object (e.g., when the three-dimensional object is moved within the three-dimensional environment). In some examples, the orientation in which the three-dimensional object is displayed in the three-dimensional environment is selected by a user of the electronic device or automatically selected by the electronic device. For example, when initiating presentation of the three-dimensional object in the three-dimensional environment, the user may select a particular orientation for the three-dimensional object or the electronic device may automatically select the orientation for the three-dimensional object (e.g., based on a type of the three-dimensional object).

In some examples, a three-dimensional object can be displayed in the three-dimensional environment in a world-locked orientation, a body-locked orientation, a tilt-locked orientation, or a head-locked orientation, as described below. As used herein, an object that is displayed in a body-locked orientation in a three-dimensional environment has a distance and orientation offset relative to a portion of the user's body (e.g., the user's torso). Alternatively, in some examples, a body-locked object has a fixed distance from the user without the orientation of the content being referenced to any portion of the user's body (e.g., may be displayed in the same cardinal direction relative to the user, regardless of head and/or body movement). Additionally or alternatively, in some examples, the body-locked object may be configured to always remain gravity or horizon (e.g., normal to gravity) aligned, such that head and/or body changes in the roll direction would not cause the body-locked object to move within the three-dimensional environment. Rather, translational movement in either configuration would cause the body-locked object to be repositioned within the three-dimensional environment to maintain the distance offset.

As used herein, an object that is displayed in a head-locked orientation in a three-dimensional environment has a distance and orientation offset relative to the user's head. In some examples, a head-locked object moves within the three-dimensional environment as the user's head moves (as the viewpoint of the user changes).

As used herein, an object that is displayed in a world-locked orientation in a three-dimensional environment does not have a distance or orientation offset relative to the user.

As used herein, an object that is displayed in a tilt-locked orientation in a three-dimensional environment (referred to herein as a tilt-locked object) has a distance offset relative to the user, such as a portion of the user's body (e.g., the user's torso) or the user's head. In some examples, a tilt-locked object is displayed at a fixed orientation relative to the three-dimensional environment. In some examples, a tilt-locked object moves according to a polar (e.g., spherical) coordinate system centered at a pole through the user (e.g., the user's head). For example, the tilt-locked object is moved in the three-dimensional environment based on movement of the user's head within a spherical space surrounding (e.g., centered at) the user's head. Accordingly, if the user tilts their head (e.g., upward or downward in the pitch direction) relative to gravity, the tilt-locked object would follow the head tilt and move radially along a sphere, such that the tilt-locked object is repositioned within the three-dimensional environment to be the same distance offset relative to the user as before the head tilt while optionally maintaining the same orientation relative to the three-dimensional environment. In some examples, if the user moves their head in the roll direction (e.g., clockwise or counterclockwise) relative to gravity, the tilt-locked object is not repositioned within the three-dimensional environment.

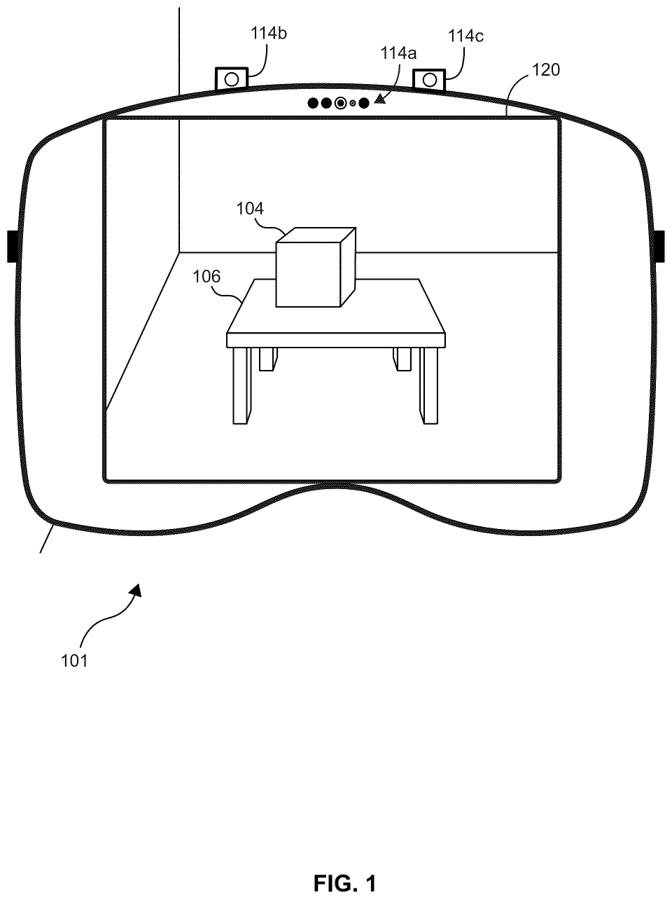

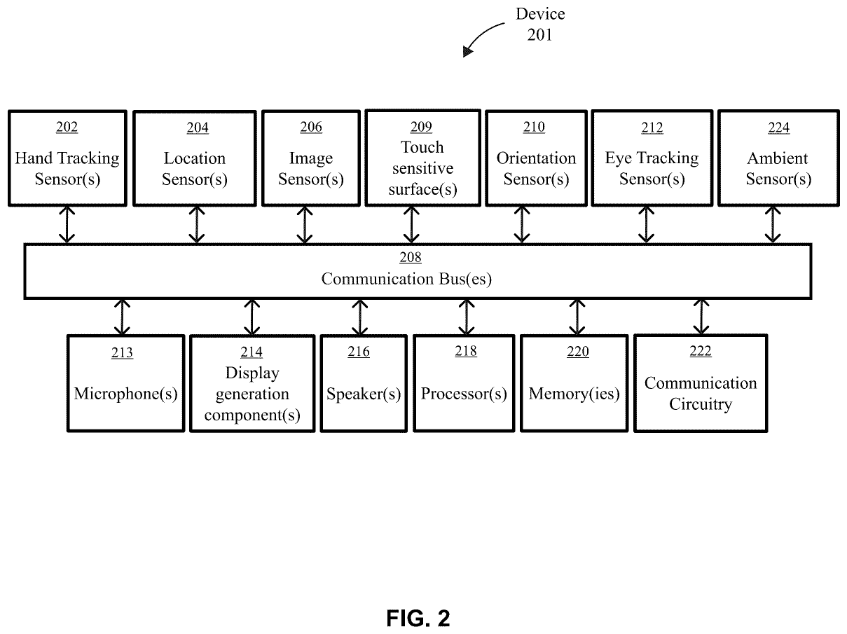

FIG. 1 illustrates an electronic device 101 presenting an extended reality (XR) environment (e.g., a computer-generated environment optionally including representations of physical and/or virtual objects) according to some examples of the disclosure. In some examples, as shown in FIG. 1, electronic device 101 is a head-mounted display or other head-mountable device configured to be worn on a head of a user of the electronic device 101. Examples of electronic device 101 are described below with reference to the architecture block diagram of FIG. 2. As shown in FIG. 1, electronic device 101 and table 106 are located in a physical environment. The physical environment may include physical features such as a physical surface (e.g., floor, walls) or a physical object (e.g., table, lamp, etc.). In some examples, electronic device 101 may be configured to detect and/or capture images of physical environment including table 106 (illustrated in the field of view of electronic device 101).

In some examples, as shown in FIG. 1, electronic device 101 includes one or more internal image sensors 114a oriented towards a face of the user (e.g., eye tracking cameras described below with reference to FIG. 2). In some examples, internal image sensors 114a are used for eye tracking (e.g., detecting a gaze of the user). Internal image sensors 114a are optionally arranged on the left and right portions of display 120 to enable eye tracking of the user's left and right eyes. In some examples, electronic device 101 also includes external image sensors 114b and 114c facing outwards from the user to detect and/or capture the physical environment of the electronic device 101 and/or movements of the user's hands or other body parts.

In some examples, display 120 has a field of view visible to the user (e.g., that may or may not correspond to a field of view of external image sensors 114b and 114c). Because display 120 is optionally part of a head-mounted device, the field of view of display 120 is optionally the same as or similar to the field of view of the user's eyes. In other examples, the field of view of display 120 may be smaller than the field of view of the user's eyes. In some examples, electronic device 101 may be an optical see-through device in which display 120 is a transparent or translucent display through which portions of the physical environment may be directly viewed. In some examples, display 120 may be included within a transparent lens and may overlap all or only a portion of the transparent lens. In other examples, electronic device may be a video-passthrough device in which display 120 is an opaque display configured to display images of the physical environment captured by external image sensors 114b and 114c.

In some examples, in response to a trigger, the electronic device 101 may be configured to display a virtual object 104 in the XR environment represented by a cube illustrated in FIG. 1, which is not present in the physical environment, but is displayed in the XR environment positioned on the top of real-world table 106 (or a representation thereof). Optionally, virtual object 104 can be displayed on the surface of the table 106 in the XR environment displayed via the display 120 of the electronic device 101 in response to detecting the planar surface of table 106 in the physical environment 100.

It should be understood that virtual object 104 is a representative virtual object and one or more different virtual objects (e.g., of various dimensionality such as two-dimensional or other three-dimensional virtual objects) can be included and rendered in a three-dimensional XR environment. For example, the virtual object can represent an application or a user interface displayed in the XR environment. In some examples, the virtual object can represent content corresponding to the application and/or displayed via the user interface in the XR environment. In some examples, the virtual object 104 is optionally configured to be interactive and responsive to user input (e.g., air gestures, such as air pinch gestures, air tap gestures, and/or air touch gestures), such that a user may virtually touch, tap, move, rotate, or otherwise interact with, the virtual object 104.

In some examples, displaying an object in a three-dimensional environment may include interaction with one or more user interface objects in the three-dimensional environment. For example, initiation of display of the object in the three-dimensional environment can include interaction with one or more virtual options/affordances displayed in the three-dimensional environment. In some examples, a user's gaze may be tracked by the electronic device as an input for identifying one or more virtual options/affordances targeted for selection when initiating display of an object in the three-dimensional environment. For example, gaze can be used to identify one or more virtual options/affordances targeted for selection using another selection input. In some examples, a virtual option/affordance may be selected using hand-tracking input detected via an input device in communication with the electronic device. In some examples, objects displayed in the three-dimensional environment may be moved and/or reoriented in the three-dimensional environment in accordance with movement input detected via the input device.

In the discussion that follows, an electronic device that is in communication with a display generation component and one or more input devices is described. It should be understood that the electronic device optionally is in communication with one or more other physical user-interface devices, such as a touch-sensitive surface, a physical keyboard, a mouse, a joystick, a hand tracking device, an eye tracking device, a stylus, etc. Further, as described above, it should be understood that the described electronic device, display and touch-sensitive surface are optionally distributed amongst two or more devices. Therefore, as used in this disclosure, information displayed on the electronic device or by the electronic device is optionally used to describe information outputted by the electronic device for display on a separate display device (touch-sensitive or not). Similarly, as used in this disclosure, input received on the electronic device (e.g., touch input received on a touch-sensitive surface of the electronic device, or touch input received on the surface of a stylus) is optionally used to describe input received on a separate input device, from which the electronic device receives input information.

The device typically supports a variety of applications, such as one or more of the following: a drawing application, a presentation application, a word processing application, a website creation application, a disk authoring application, a spreadsheet application, a gaming application, a telephone application, a video conferencing application, an e-mail application, an instant messaging application, a workout support application, a photo management application, a digital camera application, a digital video camera application, a web browsing application, a digital music player application, a television channel browsing application, and/or a digital video player application.

FIG. 2 illustrates a block diagram of an example architecture for an electronic device 201 according to some examples of the disclosure. In some examples, electronic device 201 includes one or more electronic devices. For example, the electronic device 201 may be a portable device, an auxiliary device in communication with another device, a head-mounted display, etc., respectively. In some examples, electronic device 201 corresponds to electronic device 101 described above with reference to FIG. 1.

As illustrated in FIG. 2, the electronic device 201 optionally includes various sensors, such as one or more hand tracking sensors 202, one or more location sensors 204, one or more image sensors 206 (optionally corresponding to internal image sensors 114a and/or external image sensors 114b and 114c in FIG. 1), one or more touch-sensitive surfaces 209, one or more motion and/or orientation sensors 210, one or more eye tracking sensors 212, one or more microphones 213 or other audio sensors, one or more body tracking sensors (e.g., torso and/or head tracking sensors), one or more display generation components 214, optionally corresponding to display 120 in FIG. 1, one or more microphones 216, one or more processors 218, one or more memories 220, and/or communication circuitry 222. One or more communication buses 208 are optionally used for communication between the above-mentioned components of electronic devices 201.

Communication circuitry 222 optionally includes circuitry for communicating with electronic devices, networks, such as the Internet, intranets, a wired network and/or a wireless network, cellular networks, and wireless local area networks (LANs). Communication circuitry 222 optionally includes circuitry for communicating using near-field communication (NFC) and/or short-range communication, such as Bluetooth®.

Processor(s) 218 include one or more general processors, one or more graphics processors, and/or one or more digital signal processors. In some examples, memory 220 is a non-transitory computer-readable storage medium (e.g., flash memory, random access memory, or other volatile or non-volatile memory or storage) that stores computer-readable instructions configured to be executed by processor(s) 218 to perform the techniques, processes, and/or methods described below. In some examples, memory 220 can include more than one non-transitory computer-readable storage medium. A non-transitory computer-readable storage medium can be any medium (e.g., excluding a signal) that can tangibly contain or store computer-executable instructions for use by or in connection with the instruction execution system, apparatus, or device. In some examples, the storage medium is a transitory computer-readable storage medium. In some examples, the storage medium is a non-transitory computer-readable storage medium. The non-transitory computer-readable storage medium can include, but is not limited to, magnetic, optical, and/or semiconductor storages. Examples of such storage include magnetic disks, optical discs based on compact disc (CD), digital versatile disc (DVD), or Blu-ray technologies, as well as persistent solid-state memory such as flash, solid-state drives, and the like.

In some examples, display generation component(s) 214 include a single display (e.g., a liquid-crystal display (LCD), organic light-emitting diode (OLED), or other types of display). In some examples, display generation component(s) 214 includes multiple displays. In some examples, display generation component(s) 214 can include a display with touch capability (e.g., a touch screen), a projector, a holographic projector, a retinal projector, a transparent or translucent display, etc. In some examples, electronic device 201 includes touch-sensitive surface(s) 209, respectively, for receiving user inputs, such as tap inputs and swipe inputs or other gestures. In some examples, display generation component(s) 214 and touch-sensitive surface(s) 209 form touch-sensitive display(s) (e.g., a touch screen integrated with electronic device 201 or external to electronic device 201 that is in communication with electronic device 201).

Electronic device 201 optionally includes image sensor(s) 206. Image sensors(s) 206 optionally include one or more visible light image sensors, such as charged coupled device (CCD) sensors, and/or complementary metal-oxide-semiconductor (CMOS) sensors operable to obtain images of physical objects from the real-world environment. Image sensor(s) 206 also optionally include one or more infrared (IR) sensors, such as a passive or an active IR sensor, for detecting infrared light from the real-world environment. For example, an active IR sensor includes an IR emitter for emitting infrared light into the real-world environment. Image sensor(s) 206 also optionally include one or more cameras configured to capture movement of physical objects in the real-world environment. Image sensor(s) 206 also optionally include one or more depth sensors configured to detect the distance of physical objects from electronic device 201. In some examples, information from one or more depth sensors can allow the device to identify and differentiate objects in the real-world environment from other objects in the real-world environment. In some examples, one or more depth sensors can allow the device to determine the texture and/or topography of objects in the real-world environment.

In some examples, electronic device 201 uses CCD sensors, event cameras, and depth sensors in combination to detect the physical environment around electronic device 201. In some examples, image sensor(s) 206 include a first image sensor and a second image sensor. The first image sensor and the second image sensor work in tandem and are optionally configured to capture different information of physical objects in the real-world environment. In some examples, the first image sensor is a visible light image sensor and the second image sensor is a depth sensor. In some examples, electronic device 201 uses image sensor(s) 206 to detect the position and orientation of electronic device 201 and/or display generation component(s) 214 in the real-world environment. For example, electronic device 201 uses image sensor(s) 206 to track the position and orientation of display generation component(s) 214 relative to one or more fixed objects in the real-world environment.

In some examples, electronic device 201 includes microphone(s) 213 or other audio sensors. Electronic device 201 optionally uses microphone(s) 213 to detect sound from the user and/or the real-world environment of the user. In some examples, microphone(s) 213 includes an array of microphones (a plurality of microphones) that optionally operate in tandem, such as to identify ambient noise or to locate the source of sound in space of the real-world environment.

Electronic device 201 includes location sensor(s) 204 for detecting a location of electronic device 201 and/or display generation component(s) 214. For example, location sensor(s) 204 can include a global positioning system (GPS) receiver that receives data from one or more satellites and allows electronic device 201 to determine the device's absolute position in the physical world.

Electronic device 201 includes orientation sensor(s) 210 for detecting orientation and/or movement of electronic device 201 and/or display generation component(s) 214. For example, electronic device 201 uses orientation sensor(s) 210 to track changes in the position and/or orientation of electronic device 201 and/or display generation component(s) 214, such as with respect to physical objects in the real-world environment. Orientation sensor(s) 210 optionally include one or more gyroscopes and/or one or more accelerometers.

Electronic device 201 includes hand tracking sensor(s) 202 and/or eye tracking sensor(s) 212 (and/or other body tracking sensor(s), such as leg, torso and/or head tracking sensor(s)), in some examples. Hand tracking sensor(s) 202 are configured to track the position/location of one or more portions of the user's hands, and/or motions of one or more portions of the user's hands with respect to the extended reality environment, relative to the display generation component(s) 214, and/or relative to another defined coordinate system. Eye tracking sensor(s) 212 are configured to track the position and movement of a user's gaze (eyes, face, or head, more generally) with respect to the real-world or extended reality environment and/or relative to the display generation component(s) 214. In some examples, hand tracking sensor(s) 202 and/or eye tracking sensor(s) 212 are implemented together with the display generation component(s) 214. In some examples, the hand tracking sensor(s) 202 and/or eye tracking sensor(s) 212 are implemented separate from the display generation component(s) 214.

In some examples, the hand tracking sensor(s) 202 (and/or other body tracking sensor(s), such as leg, torso and/or head tracking sensor(s)) can use image sensor(s) 206 (e.g., one or more IR cameras, 3D cameras, depth cameras, etc.) that capture three-dimensional information from the real-world including one or more hands (e.g., of a human user). In some examples, the hands can be resolved with sufficient resolution to distinguish fingers and their respective positions. In some examples, one or more image sensors 206 are positioned relative to the user to define a field of view of the image sensor(s) 206 and an interaction space in which finger/hand position, orientation and/or movement captured by the image sensors are used as inputs (e.g., to distinguish from a user's resting hand or other hands of other persons in the real-world environment). Tracking the fingers/hands for input (e.g., gestures, touch, tap, etc.) can be advantageous in that it does not require the user to touch, hold or wear any sort of beacon, sensor, or other marker.

In some examples, eye tracking sensor(s) 212 includes at least one eye tracking camera (e.g., infrared (IR) cameras) and/or illumination sources (e.g., IR light sources, such as LEDs) that emit light towards a user's eyes. The eye tracking cameras may be pointed towards a user's eyes to receive reflected IR light from the light sources directly or indirectly from the eyes. In some examples, both eyes are tracked separately by respective eye tracking cameras and illumination sources, and a focus/gaze can be determined from tracking both eyes. In some examples, one eye (e.g., a dominant eye) is tracked by one or more respective eye tracking cameras/illumination sources.

Electronic device 201 includes ambient sensor(s) 224 for detecting ambient environmental conditions in the real-world environment. In some examples, the electronic device 201 includes ambient light sensors to detect the amount of ambient light present. For example, ambient light sensors include photodiodes, photonic ICs, and/or phototransistors. In some examples, the ambient sensor(s) 224 are implemented together with the image sensor(s) 206.

Electronic device 201 is not limited to the components and configuration of FIG. 2, but can include fewer, other, or additional components in multiple configurations. In some examples, electronic device 201 can be implemented between two electronic devices (e.g., as a system). In some such examples, each of (or more) electronic device may each include one or more of the same components discussed above, such as various sensors, one or more display generation components, one or more speakers, one or more processors, one or more memories, and/or communication circuitry. A person or persons using electronic device 201, is optionally referred to herein as a user or users of the device.

Attention is now directed towards an electronic device (e.g., corresponding to electronic device 201 and/or electronic device 101) that can capture biometric data of a user passively while the user is wearing and/or using the electronic device. As discussed below, the electronic device may detect, using one or more input devices (e.g., orientation sensor(s) 210, image sensor(s) 206, ambient sensor(s) 224, and/or other sensors) biometric data including pupil dilation, walking asymmetry, and other user health data. In some examples, the electronic device may use the biometric data to establish a baseline. In some examples, if the detected biometric data deviates from the baseline biometric data (e.g., by more than a threshold amount), then the electronic device may display one or more virtual objects in a three-dimensional environment presented at the electronic device. Baseline biometric data is unique to each user. Other humans (e.g., during doctor's visits) may not be able to distinguish unusual biometric data from normal biometric data, as described in further detail below. Biometric measurements may change based on environmental factors (e.g., lighting, weather, sleep quality, or other factors). Some existing biometric trackers require that a user manually capture biometric data. These existing trackers do not automatically track and capture baseline biometric data.

To solve the technical problem outlined above, exemplary methods and/or systems are provided where the electronic device automatically records biometric data. When an event is detected by the electronic device (e.g., rapid acceleration/deceleration, or rapid change of viewpoint), the electronic device may actively monitor biometric data to detect deviations in biometric data. If deviations are detected, the user may be notified of a potential deviation. Triggering actively monitoring biometric data (e.g., by capturing second biometric data as described below) when an event that satisfies the one or more first criteria is detected reduces the number of passively running sensors, or the duration and/or number of measurements by the sensors, thereby saving power and/or other computing resources of the electronic device. Furthermore, automatically initiating an emergency response (e.g., including describing and/or summarizing a user's surroundings) in response to the second biometric data indicating a loss of consciousness reduces the number of inputs needed to transmit an emergency response, thereby saving power and/or other computing resources of the electronic device.

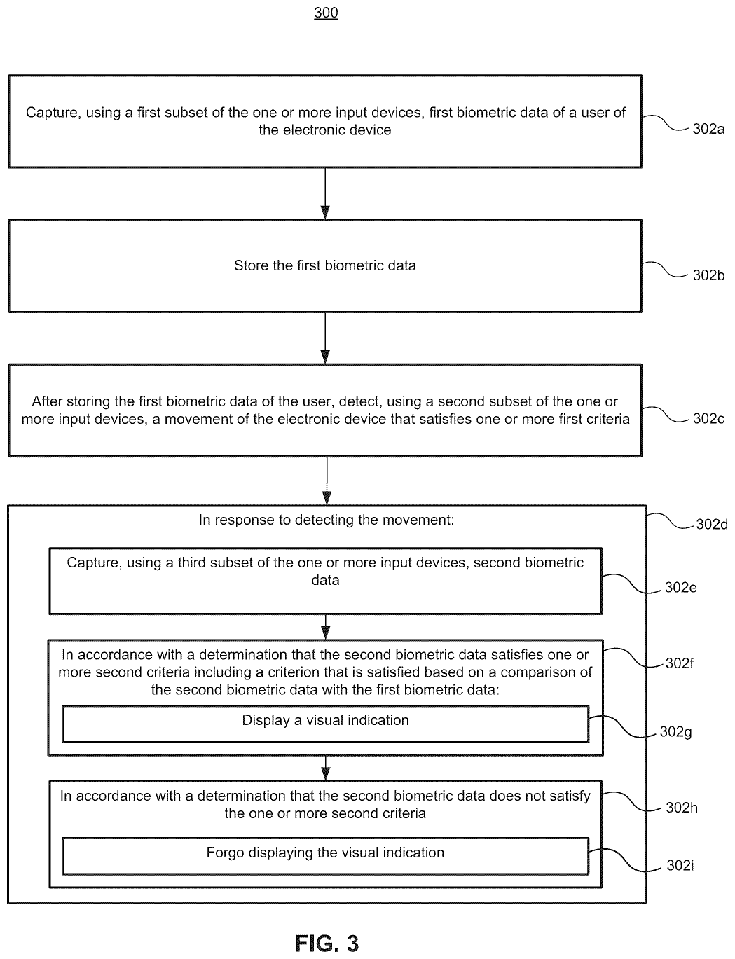

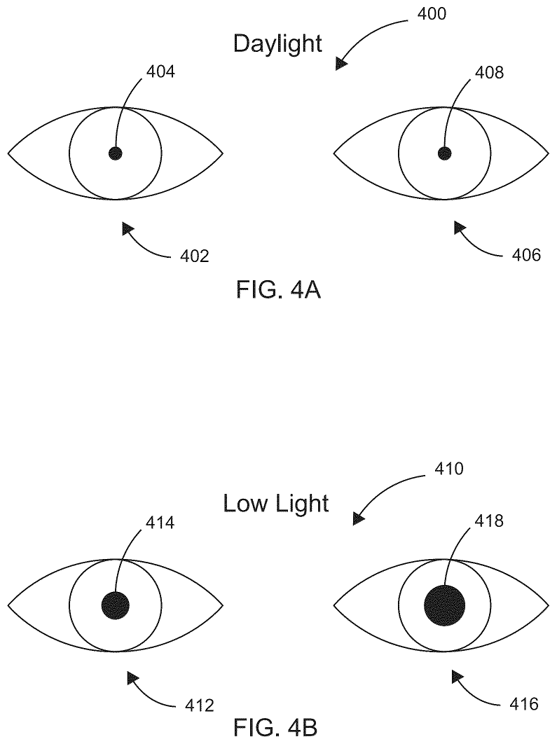

FIG. 3 illustrates a flow chart of an example process of an electronic device recording biometric data and displaying an indication in response to detecting a movement of the electronic device. FIGS. 4A-4B, 5A-5B, 6A-6C, and 7A-7E are used to illustrate the processes described below, including process 300 in FIG. 3.

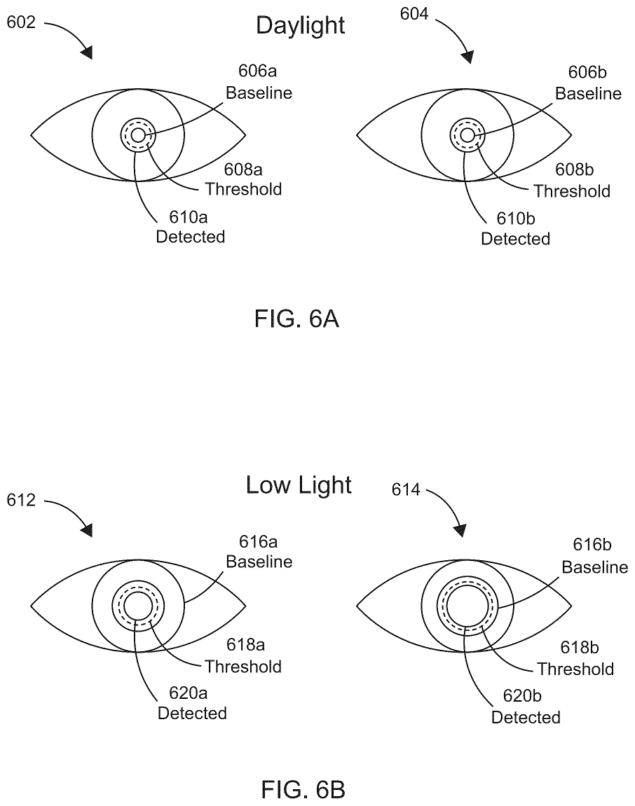

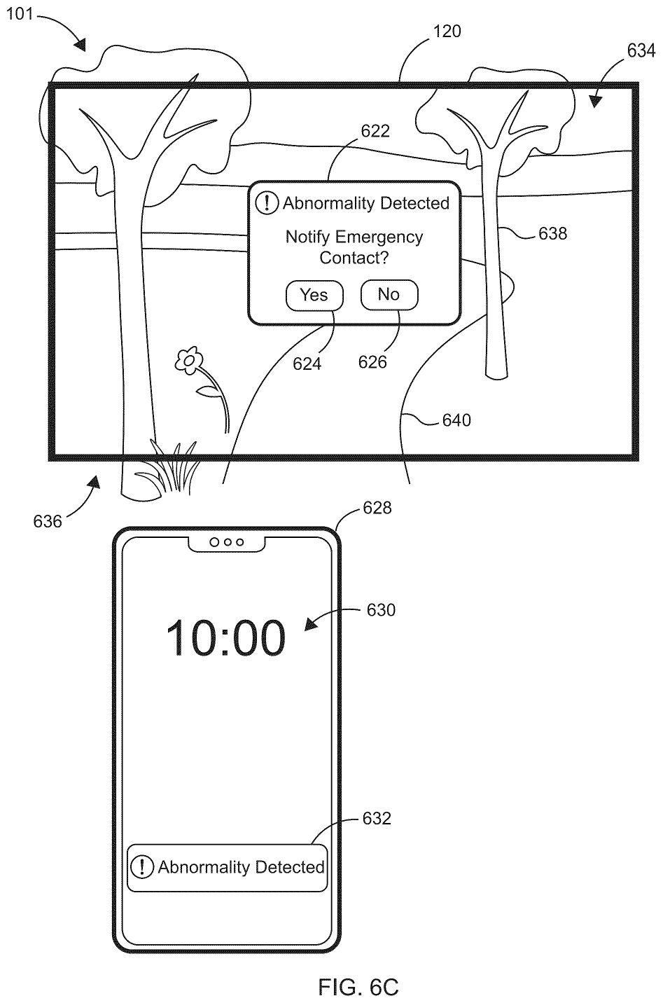

In some examples, process 300 begins at an electronic device in communication with one or more displays and one or more input devices. In some examples, the electronic device is optionally a head-mounted display similar or corresponding to device 201 of FIG. 2. As shown in FIG. 3, in some examples, the electronic device, such as electronic device 101, captures (302a), using a first subset of the one or more input devices, first biometric data of a user of the electronic device. For example, and as described in FIGS. 4A-4B, the first biometric data of the user includes data relating to pupil dilation of each eye of the user. For example, the pupil of each eye dilates and contracts in response to environmental factors (e.g., light) and/or emotions. The first biometric data may include data relating to ambient light and mood of the user and the resulting pupil dilation or constriction. Additionally, in some examples, the first biometric data includes other data relating to a user's health. For example, the first biometric data may include sleep data (e.g., sleep quality, such as an amount (e.g., in minutes and/or hours) of REM sleep, deep sleep, and light sleep, and/or sleep time), walking asymmetry, and/or the presence of nausea. In some examples, the first biometric data includes data related to eye/pupil movement. For example, the electronic device 101 captures vertical and horizontal eye/pupil movements. In some examples, health data may be recorded by a second electronic device (e.g., a phone, smart watch, tablet, or other device) related to (e.g., in communication with) the electronic device, such as second electronic device 628 in FIG. 6C, and transmitted to the electronic device. For example, the second electronic device may be wirelessly connected to the electronic device or may share a user account with the electronic device. In some examples, the second electronic device may include sensors that monitor sleep (e.g., motion sensors) and walking patterns. The first subset of the one or more input devices includes various sensors, as described above, including ambient sensor(s) 224, eye tracking sensor(s) 212, and/or orientation sensor(s) 210.

In some examples, the electronic device stores (302b) the first biometric data. In some examples, the electronic device stores the first biometric data including data received from a second electronic device on the electronic device. In some examples, the first biometric data serves as a baseline for the user and is used to determine whether a different set of biometric data is abnormal relative to the first biometric data.

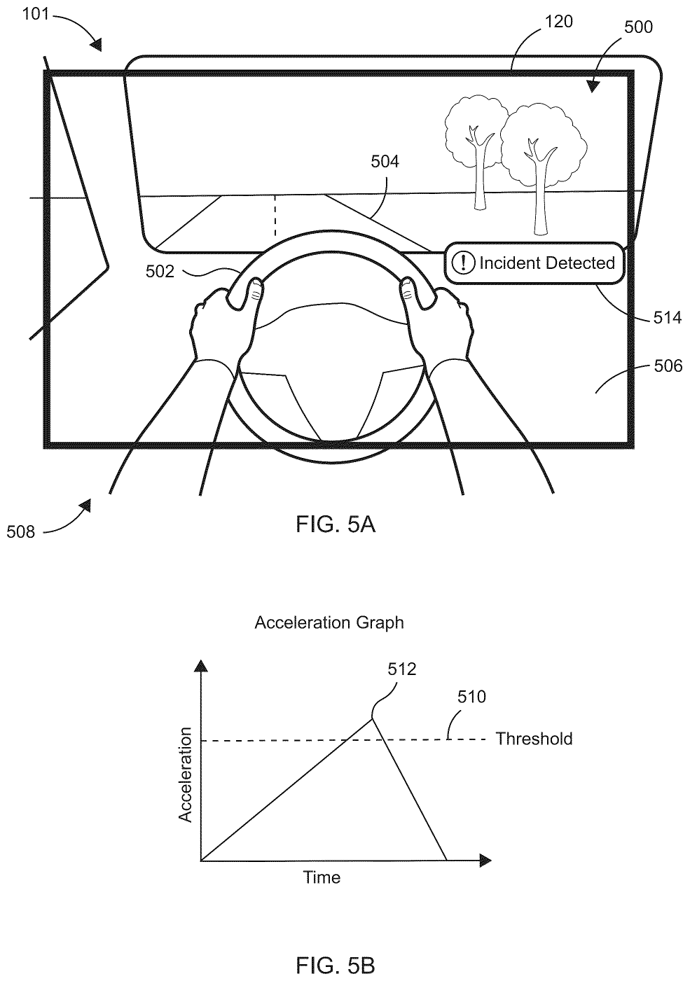

In some examples, after storing the first biometric data of the user, the electronic device detects (302c), using a second subset of the one or more input devices, a movement of the electronic device that satisfies one or more first criteria. In some examples, the second subset of the one or more input devices includes motion sensors, such as orientation sensor(s) 210, location sensor(s) 204, and/or image sensor(s) 206. In some examples, the one or more first criteria is satisfied when the movement exceeds a threshold acceleration, a rapid change in acceleration is identified (e.g., greater than 1 m/s², 5 m/s², or 10 m/s²), a rapid change in the portion of the physical environment that is included in the three-dimensional environment (e.g., the user was looking at trees and is suddenly looking at the sky), and/or a combination of the above are identified. For example, as shown in FIG. 5A, the user is in a car and a sudden change in acceleration was detected (shown in FIG. 5B). Additionally, as shown in FIG. 5B, the peak acceleration exceeds a threshold acceleration. In some examples, and as shown with visual indication 514 in FIG. 5A, the electronic device presents a visual indication in response to detecting a movement satisfying the one or more first criteria.

In some examples, in response to detecting the movement (302d), the electronic device captures (302e), using a third subset of the one or more input devices, second biometric data. In some examples, the third subset of the one or more input devices is the same subset as the first subset of the one or more input devices described in step 302a. In some examples, the second biometric data is the same as the first biometric data. For example, the same types of data (e.g., pupil dilation, pupil movement, sleep, and other data discussed above) are captured. In some examples, the electronic device captures the second biometric data at an interval greater (e.g., more frequently) than that of the first biometric data. For example, if the first biometric data is captured every minute, then the second biometric data may be captured every 30 seconds, 10 seconds, 1 second, or 0.1 seconds. In some examples, the first biometric data is captured every 1 second, 30 seconds, 1 minute, 30 minutes, or every hour, and the second biometric data is captured at a rate quicker than the rate the first biometric data is captured. In some examples, the second biometric data includes pupil dilation data, eye/pupil movement data, ambient light data, sleep data, walking asymmetry data, and other user health data that is also captured in the first biometric data.

In some examples, in response to detecting the movement, in accordance with a determination that the second biometric data satisfies one or more second criteria including a criterion that is satisfied based on a comparison of the second biometric data with the first biometric data (302f), the electronic device displays (302g) a visual indication, such as the visual indication shown in FIG. 6C. In some examples, the one or more second criteria are satisfied when the second biometric data is outside a threshold amount of the first biometric data. For example, as shown in FIGS. 6A and 6B, the pupil dilation and constriction recorded is outside a threshold amount determined by the baseline biometric data (e.g., first biometric data). In some examples, and as described herein, pupil dilation and constriction are affected by environmental factors. In some examples, the electronic device considers an environmental context factor (e.g., current ambient lighting) and/or emotional state of the user to determine whether the pupillary response exceeds a threshold amount. For example, data taken during low light conditions is not compared to data taken during high light conditions. Similarly, data taken while the user is detected to be angry is not compared to data taken when the user is detected to be calm. After the electronic device determines that second biometric data is abnormal relative to the first biometric data, the electronic device displays a visual indication in the three-dimensional environment to alert the user that an abnormality has been detected. In some examples, the electronic device also displays selectable options to allow the user to notify a pre-determined contact. For example, the pre-determined contact may be a contact that the user selects as an emergency contact. In some examples, the pre-determined contact may be a commonly contacted contact (e.g., a person that the user interacts with frequently).

In some examples, in response to detecting the movement, in accordance with a determination that the second biometric data does not satisfy one or more second criteria including a criterion that is satisfied based on a comparison of the second biometric data with the first biometric data (302h), the electronic device forgoes displaying a visual indication, such as the visual indication shown in FIG. 6C. In some examples, after the movement described above is detected, the electronic device tracks and records the second biometric data at a time interval. The electronic device progressively records the second biometric data less frequently after a threshold amount of time has passed (e.g., 10 minutes, 30 minutes, or 1 hour) without detecting an abnormality. For example, the electronic device records the second biometric data every 10 seconds. After 30 minutes of recording every 10 seconds without detecting an abnormality has passed, the electronic device begins recording at a greater time interval (e.g., less frequently, such as every 30 seconds, every minute, every 30 minutes, or every hour). In some examples, after a threshold amount of time has passed, the electronic device slowly begins increasing the time interval until the time interval is the same as the time interval used to record the first biometric data, as described above.

Alternatively or additionally, in some examples, the electronic device (e.g., electronic device 101 and/or electronic device 628) displays the visual indication (e.g., visual indication 622 and/or visual indication 632) without detecting the movement of the electronic device. For example, the electronic device captures the second set of biometric data at a set time interval (e.g., 30 seconds, 1 min, 15 min, 30 min, or 1 hour) after capturing the first set of biometric data. In some examples, after capturing the second biometric data, the electronic device compares the second biometric data to the first biometric data. In other words, the electronic device captures biometric data passively as the user is using the electronic device (e.g., electronic device 101) and compares a currently captured biometric data to a previously captured biometric data. In accordance with the determination that the second biometric data satisfies the one or more second criteria, the electronic device displays the visual indication(s) as described above. In some examples, abnormalities, like rapid eye/pupil movement, are present without the electronic device detecting a movement of the electronic device, as described in further detail in FIGS. 5A-5B. In some examples, rapid eye/pupil movement is indicative of abnormal eye activity (e.g., nystagmus related health conditions).

It is understood that process 300 is an example and that more, fewer, or different operations can be performed in the same or in a different order. Additionally, the operations in process 300 described above are, optionally, implemented by running one or more functional modules in an information processing apparatus such as general-purpose processors (e.g., as described with respect to FIG. 2) or application specific chips, and/or by other components of FIG. 2.

FIGS. 4A-4B illustrate example recordings of pupil dilation during different light conditions according to some examples of the disclosure. FIG. 4A illustrates an example of a user's eyes 400, including pupil dilation, during daylight. In some examples, the user's pupils constrict during high light situations (e.g., bright light, daylight, and/or looking at a bright screen). For example, while the user is located in an outdoors environment during a sunny day, the user's pupils will constrict, as shown in FIG. 4A. In FIG. 4A, pupil 404 of the left eye 402 and pupil 408 of the right eye 406 constrict an equal amount in response to the same bright light stimulus. In some examples, an electronic device 101, described in detail above, records the pupil dilation of the left eye 402 and the right eye 406 in response to the bright light stimulus. In some examples, the electronic device 101 uses one or more of the sensors, as described above and controlled by the electronic device 101 to capture one or more images of a user or part of a user (e.g., one or more eyes of the user, and specifically one or more pupils of the user) while the user interacts with the electronic device 101. In some examples, the electronic device 101 uses the ambient sensor(s) 224 to capture the amount of ambient light in the physical environment. In some examples, the electronic device 101 uses internal image sensors (described in FIG. 1) such as eye tracking sensor(s) 212 to track each eye's response to the light (e.g., pupil dilation). In some examples, and as described above, the electronic device 101 stores the data relating the ambient light to the pupil dilation in response to the light. In some examples, the electronic device 101 stores the pupil dilation data of each eye (e.g., left eye 402 and right eye 406) separately.

FIG. 4B illustrates an example of a user's eyes 410 during low light conditions. In some examples, the user's pupils dilate during low light situations to allow a greater amount of light into the eyes. For example, when the user enters a dimly lit room, the user's pupils expand, as shown in FIG. 4B. In some examples, the user's pupils may dilate in response to emotional events (e.g., stress, love, anger, or other emotions/sensations). In some examples, the user's pupils expand differently. For example, the pupil 414 of the left eye 412 dilates less than the pupil 418 of the user's right eye 416, as shown in FIG. 4B. As described above, the electronic device 101 captures ambient light data and pupil dilation data of each eye (e.g., left eye 412 and right eye 416) using the one or more sensors on the electronic device 101, and stores that data as baseline biometric data. In some examples, uneven pupil dilation (and pupil constriction) are genetic traits of the user. In some examples, uneven pupil dilation may be indicative of abnormal eye activity. However, if electronic device 101 consistently records uneven pupil dilation (and constriction) during varying ambient light, then the user may have uneven pupil dilation that is not abnormal relative to the baseline. This data may be useful when detecting abnormal biometric data during an event that satisfies one or more first criteria, as described previously with reference to process 300.

In some examples, the biometric data of each eye of the user, including the ambient light data, may be recorded by the electronic device 101 passively (e.g., without initiation from the user), through other activities. The electronic device 101 may record the biometric data at a specific time interval (e.g., every 1 second, 10 seconds, 1 minute, 5 minutes, 10 minutes, 30 minutes, or 1 hour). For example, applications may be running on the electronic device 101 while the electronic device 101 records biometric data. In some examples, the electronic device 101 uses biometric data for other functions. For example, the electronic device 101 may use the biometric data to recognize the user of the electronic device (e.g., facial recognition or fingerprint recognition for unlocking the electronic device 101).

In some examples, a second electronic device, such as a watch and/or a phone, can transmit data to the electronic device 101. In some examples, the second electronic device is communicatively connected to the electronic device 101. For example, the second electronic device is wirelessly (e.g., Bluetooth, WiFi, or other wireless connections) connected, physically connected (e.g., with wires, Ethernet, or other physical connections), or shares the same user account as the electronic device 101. In some examples, a user may input emotional data into the second electronic device, and the second electronic device transfers that data to the electronic device 101 to be stored with the biometric data. In some examples, the second electronic device includes sensors that detect a movement that satisfies one or more first criteria, as described above in process 300 and below in FIGS. 5A-5B. For example, the second electronic device includes an accelerometer, an IMU, and other motion sensors that detects a sudden change in acceleration and/or an acceleration above a threshold acceleration. For example, the second electronic device detects a fall sustained by a user. The second electronic device may transmit the motion data to the electronic device 101 to be used to determine the movement of the user.

FIGS. 5A-5B illustrate an example of a movement of an electronic device 101 that satisfies the one or more first criteria described in the process 300.

FIG. 5A illustrates an electronic device 101 presenting, via the display 120, a three-dimensional environment 500 from a point of view of the user of the electronic device 101 (e.g., facing a steering wheel 502 and a road 504 in a car 506 in which electronic device 101 is located). In some examples, a viewpoint of a user determines what content (e.g., physical and/or virtual objects) is visible in a viewport (e.g., a view of the three-dimensional environment 500 visible to the user via one or more display(s) 120, a display or a pair of display modules that provide stereoscopic content to different eyes of the same user). In some examples, the (virtual) viewport has a viewport boundary that defines an extent of the three-dimensional environment 500 that is visible to the user via the display 120 in FIG. 5A. In some examples, the region defined by the viewport boundary is smaller than a range of vision of the user in one or more dimensions (e.g., based on the range of vision of the user, size, optical properties or other physical characteristics of the one or more displays, and/or the location and/or orientation of the one or more displays relative to the eyes of the user). In some examples, the region defined by the viewport boundary is larger than a range of vision of the user in one or more dimensions (e.g., based on the range of vision of the user, size, optical properties or other physical characteristics of the one or more displays, and/or the location and/or orientation of the one or more displays relative to the eyes of the user). The viewport and viewport boundary typically move as the one or more displays move (e.g., moving with a head of the user for a head mounted device or moving with a hand of a user for a handheld device such as a tablet or smartphone). A viewpoint of a user determines what content is visible in the viewport, a viewpoint generally specifies a location and a direction relative to the three-dimensional environment, and as the viewpoint shifts, the view of the three-dimensional environment will also shift in the viewport. For a head mounted device, a viewpoint is typically based on a location, a direction of the head, face, and/or eyes of a user to provide a view of the three-dimensional environment that is perceptually accurate and provides an immersive experience when the user is using the head-mounted device. For a handheld or stationed device, the viewpoint shifts as the handheld or stationed device is moved and/or as a position of a user relative to the handheld or stationed device changes (e.g., a user moving toward, away from, up, down, to the right, and/or to the left of the device). For devices that include displays with video passthrough, portions of the physical environment that are visible (e.g., displayed, and/or projected) via the one or more displays are based on a field of view of one or more cameras in communication with the displays which typically move with the displays (e.g., moving with a head of the user for a head-mounted device or moving with a hand of a user for a handheld device such as a tablet or smartphone) because the viewpoint of the user moves as the field of view of the one or more cameras moves (and the appearance of one or more virtual objects displayed via the one or more displays is updated based on the viewpoint of the user (e.g., displayed positions and poses of the virtual objects are updated based on the movement of the viewpoint of the user)). For displays with optical see through, portions of the physical environment that are visible (e.g., optically visible through one or more partially or fully transparent portions of the display generation component) via the one or more displays are based on a field of view of a user through the partially or fully transparent portion(s) of the display generation component (e.g., moving with a head of the user for a head mounted device or moving with a hand of a user for a handheld device such as a tablet or smartphone) because the viewpoint of the user moves as the field of view of the user through the partially or fully transparent portions of the displays moves (and the appearance of one or more virtual objects is updated based on the viewpoint of the user).

In FIG. 5A, the electronic device 101 includes a display 120 and a plurality of sensors as described above and controlled by the electronic device 101 to capture one or more images of a user or part of a user (e.g., one or more hands of the user) while the user interacts with the electronic device 101 and the physical environment. In some examples, virtual objects, virtual content, and/or user interfaces illustrated and described below could also be implemented on a head-mounted display that includes a display or display generation component that displays the virtual objects, virtual content, user interfaces or three-dimensional environment to the user, and sensors to detect the physical environment and/or movements of the user's hands (e.g., external sensors facing outwards from the user), and/or attention (e.g., including gaze) of the user (e.g., internal sensors facing inwards towards the face of the user). The figures herein illustrate a three-dimensional environment that is presented to the user by electronic device 101 (e.g., and displayed by the display 120 of electronic device 101). In some examples, electronic device 101 may be similar to device 101 in FIG. 1, or device 201 in FIG. 2, and/or may be a head mountable system/device and/or projection-based system/device (including a hologram-based system/device) configured to generate and present a three-dimensional environment, such as, for example, heads-up displays (HUDs), head mounted displays (HMDs), windows having integrated display capability, displays formed as lenses designed to be placed on a person's eyes (e.g., similar to contact lenses), respectively.

As shown in FIG. 5A, the electronic device 101 captures (e.g., using external image sensors 114b and 114c) one or more images of a physical environment 508 around electronic device 101, including one or more objects (e.g., steering wheel 502 and road 504) in the physical environment 508 around the electronic device 101. In some examples, the electronic device 101 displays representations of the physical environment 508 in the three-dimensional environment or portions of the physical environment 508 are visible via the display 120 of electronic device 101. For example, the three-dimensional environment 500 includes steering wheel 502 and road 504 in the physical environment 508.

In some examples, the electronic device 101 detects a movement that satisfies one or more first criteria, described in process 300, using one or more sensors (e.g., orientation sensor(s) 210, location sensor(s) 204, and/or image sensor(s) 206). In some examples, the orientation sensor(s) may detect that the movement exceeds a threshold acceleration. In some examples, the location sensors and/or motion sensors may detect a rapid change in acceleration, which satisfies one or more first criteria. In some examples, the image sensor(s) may detect a rapid change in physical environment. For example, if the head of the user was hit by a moving object (e.g., a ball) or if the user fell, the viewpoint of the user may rapidly change. Additionally, as described above, a second electronic device may detect the motion that satisfies the one or more first criteria. In FIG. 5A, electronic device 101 detects that there is a movement that satisfies the one or more first criteria. For example, in FIG. 5A, the user's car is rear ended, and in response, the electronic device 101 detects a sudden change in acceleration 512, such as shown in FIG. 5B, of the user's head. Additionally, the acceleration of electronic device 101, which detects the acceleration of the user's head, may exceed a threshold acceleration 510. As such, the force on the head of the user may be great enough to cause a concussion or other health issues.

In some examples, in response to detecting the movement that satisfies the one or more first criteria, the electronic device 101 displays a visual indication 514, as shown in FIG. 5A, in the three-dimensional environment 500 indicating that an incident (e.g., a movement that satisfies the one or more first criteria) has been detected. In response to detecting the incident, the electronic device 101 may begin recording second biometric data at a second time interval to determine if there is an abnormality in the second biometric data compared to the baseline biometric data, as described in process 300. If an abnormality is not detected after a threshold amount of time has passed, as described in process 300, then the electronic device 101 begins recording the biometric data at the original time interval and/or a time interval that is less than the second time interval.

FIGS. 6A-6C illustrate examples of the second biometric data compared to the baseline biometric data and the resulting presentation on the electronic device. FIG. 6A illustrates an example of the second biometric data compared to the baseline biometric data in daylight (e.g., high light) scenarios. Both left eye 602 and right eye 604 have similar pupillary responses in daylight. For example, the pupils for the left eye 602 and the right eye 604 constrict similar amounts in daylight. FIG. 6A shows the left pupil size 606a and the right pupil size 606b for the baseline biometric data. In some examples, the left pupil size 606a and the right pupil size 606b is an average size of the respective pupils while in a given environmental condition (e.g., light condition and/or emotional condition). Alternatively, in some examples, the size of the pupils is a median or mode of the size of the pupils taken in the baseline biometric data. In some examples, the electronic device 101 adds a threshold amount (e.g., ±0.001 mm, ±0.01 mm, or ±0.1 mm) to the left pupil size 606a and the right pupil size 606b. FIG. 6A shows an upper threshold for a left threshold pupil size 608a and a right threshold pupil size 608b for daylight conditions. In some examples, the left threshold pupil size 608a and the right threshold pupil size 608b include an upper and lower threshold. In some examples, and as shown in FIG. 6A, the electronic device 101 detects an abnormality if a detected pupil size (e.g., in the second biometric data) is larger than the threshold pupil size. FIG. 6A shows the left detected pupil size 610a and the right detected pupil size 610b exceeding the respective threshold pupil sizes (608a and 608b).

FIG. 6B illustrates an example of the second biometric data compared to the baseline biometric data in low light (e.g., a dim room or at night time) scenarios. In some examples, and as described above, each eye may have differently sized pupils. For example, as shown in FIG. 6B, the pupillary response of the right eye 614 is larger than the pupillary response of the left eye 612. Specifically, the baseline pupil size 616b of the right eye 614 is larger than the baseline pupil size 616a of the left eye 612. As such, the threshold pupil sizes may vary depending on the eye. In some examples, the threshold amount that is added and/or subtracted from the baseline pupil size is constant but the threshold pupil size is different. For example, a threshold pupil size 618b of the right eye 614 is larger than a threshold pupil size 618a of the left eye 612 because the pupil size of the right eye 614 is inherently larger than the pupil size of the left eye 612. FIG. 6B shows the lower threshold size of the respective eyes during dilation. In some examples, there is an upper and lower threshold for the left threshold pupil size and the right threshold pupil size. In some examples, and as shown in FIG. 6B, the electronic device 101 detects an abnormality if a detected pupil size (e.g., in the second biometric data) is smaller than the threshold pupil size during low light. FIG. 6B shows the left detected pupil size 620a and the right detected pupil size 620b exceeding the respective threshold pupil sizes (618a and 618b).

In response to detecting that the second biometric data is abnormal relative to the baseline, the electronic device 101 notifies the user of the abnormality by presenting visual indication 622 in three-dimensional environment 634, as shown in FIG. 6C. In some examples, the electronic device 101 presents visual indication 622 when the abnormality is detected. For example, after the event is detected, as shown in FIG. 5A, the electronic device 101 begins recording the second biometric data and compares the second biometric data to the baseline biometric data, which is described in further detail in process 300. When the electronic device 101 detects the abnormality, the user is optionally in a different physical environment 636 than previously shown in FIG. 5A (e.g., physical environment 508). In FIG. 6C, the physical environment 636 has different objects (e.g., tree 638 and sidewalk 640) than the physical environment 508 in FIG. 5A.

In some examples, and as shown in FIG. 6C, visual indication 622 includes selectable options 624 and 626, which allow the user to inform a pre-determined contact of the abnormality. As described in process 300, the user optionally selects a known contact as the pre-determined contact. In some examples, in response to receiving an input on selectable option 624, the electronic device 101 notifies the pre-determined contact (e.g., initiates a call, text, email, and/or push notification). For example, the input may be a tap input using a finger of a user, a gaze input using a user's eyes, and/or an air-pinch input using a user's fingers to select the selectable option 624. In some examples, in response to receiving an input on selectable option 626, the electronic device 101 does not notify the pre-determined contact and optionally ceases the display of visual indication 622 in the three-dimensional environment 634.

In some examples, in response to detecting that the second biometric data is abnormal relative to the baseline, the electronic device 101 transmits an indication of the abnormality to a second electronic device 628. The second electronic device 628 is optionally a portable communications device such as a mobile telephone, laptop, tablet, smart watch, or other devices described herein. In some examples, and as described in process 300, the second electronic device 628 is communicatively connected to the electronic device 101 by way of wireless connection, wired connection, or a shared user account. In some examples, the second electronic device 628 is an electronic device of the pre-determined contact discussed above.

In some examples, in response to receiving the indication of the abnormality, the second electronic device 628 displays (e.g., via a display) a visual indication 632 that an abnormality is detected, as shown in FIG. 6C. In some examples, the second electronic device 628 displays the visual indication 632 on a lock screen user interface 630 as a persistent notification. In some examples, the second electronic device 628 displays the visual indication 632 on other user interfaces of the second electronic device 628, such as a home screen user interface or other user interfaces of different applications. In some examples, the visual indication 632 is selectable to notify the pre-determined contact, as described above, about the abnormality.

In some examples, visual indication 632 and/or visual indication 622 include a recommendation for the user to visit or contact a health professional as a result of the electronic device 101 detecting an abnormality between the second biometric data and the baseline biometric data. For example, visual indication 632 and/or visual indication 622 may include text recommending a visit to a health professional such as a doctor (e.g., the user's primary care physician). In some examples, visual indication 632 and/or visual indication 622 may include one or more selectable options that are selectable to initiate transmission of a call, text, and/or email to a nearby health professional or emergency center (e.g., close to the location of the electronic device 101 and/or second electronic device 628 which is detectable by a GPS on either device) indicating the detection of the abnormality.

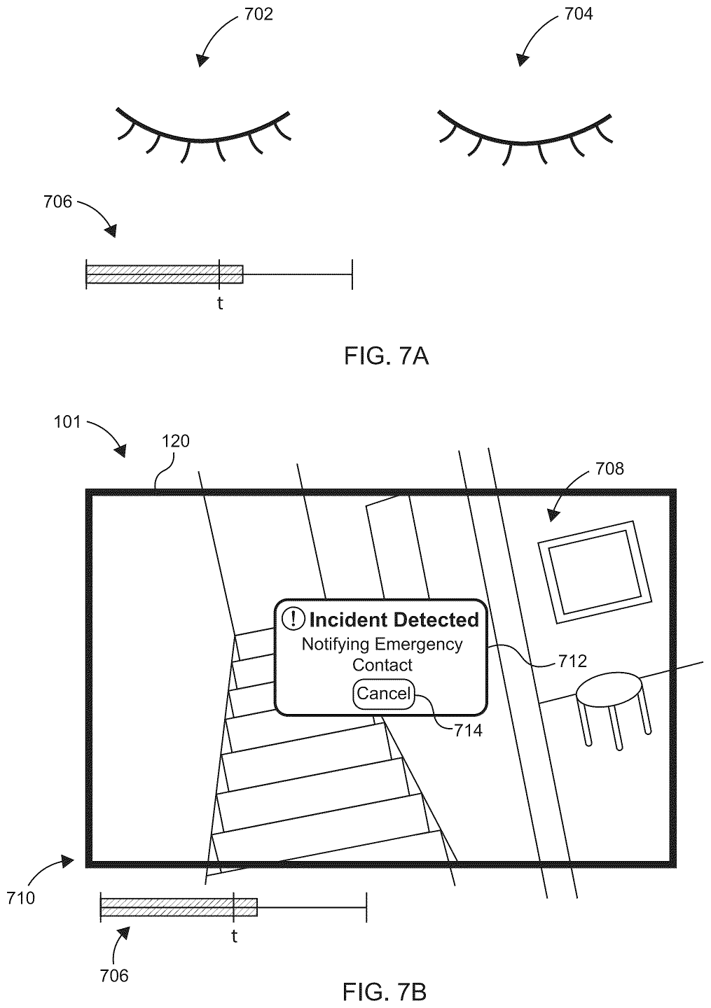

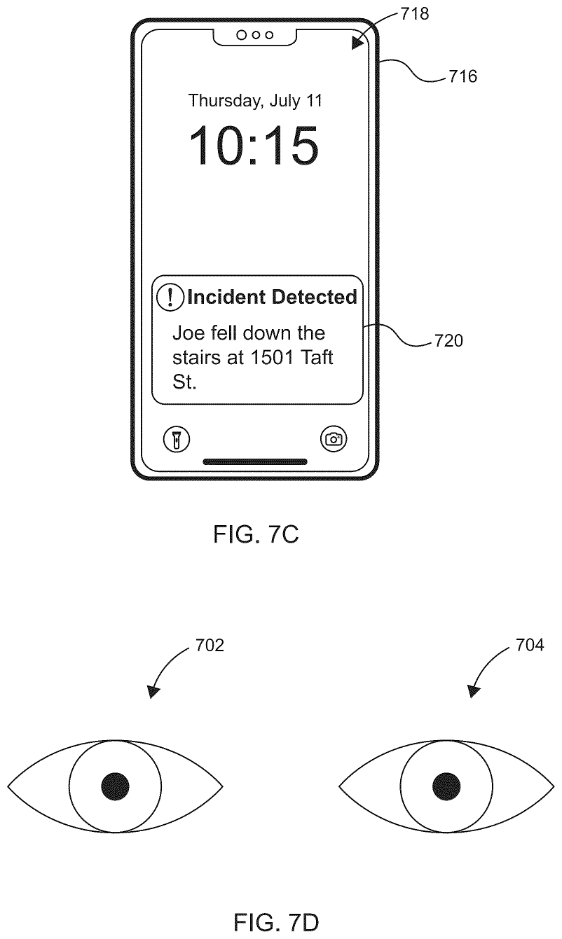

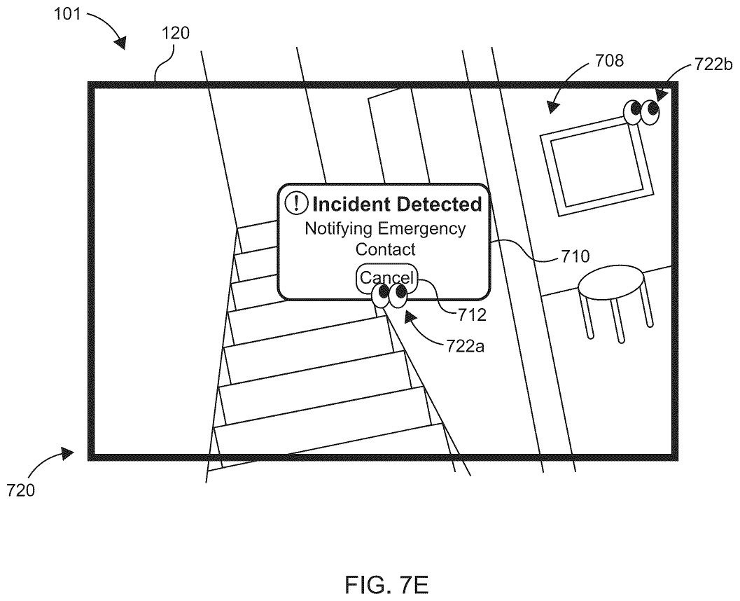

In some examples, in response to receiving the indication of the abnormality, the electronic device 101 initiates an emergency response without further input from the user. For example, instead of displaying selectable options 624 and 626, which allow the user to inform a pre-determined contact of the abnormality, the electronic device 101 automatically transmits an indication of an abnormality to the emergency contact (e.g., the predetermined contact) after a first threshold amount of time (e.g., 5 seconds, 10 seconds, 15 seconds, 30 seconds, 1 minute, 5 minutes, 30 minutes, or 1 hour) after the abnormality is detected. In some examples, the electronic device 101 initiates the emergency response by transmitting an indication of an abnormality (e.g., a phone call, a message such as an email, text message, or other forms of messages) to emergency services (e.g., 911), the user's health care provider, or other contacts. Initiating an emergency response is described in greater detail with respect to FIGS. 7A-7E.

In some examples, the electronic device 101 detects that the second biometric data is abnormal when the second biometric data is indicative of a loss of consciousness of the user, as described in greater detail in FIGS. 7A-7E. For example, after detecting the movement that satisfies the one or more first criteria, the electronic device 101 captures the second biometric data indicating that the user's eyes are closed for a threshold amount of time (e.g., 5 seconds, 10 seconds, 30 seconds, 1 minute, or 5 minutes) and/or other biometric data that is indicative of a loss of consciousness. After detecting the loss of consciousness, the electronic device 101 initiates an emergency response after a second threshold amount of time. In some examples, the second threshold amount of time a shorter threshold than the first threshold amount of time (e.g., 5 seconds, 10 seconds, 15 seconds, 30 seconds, 1 minute, 5 minutes, 30 minutes, or 1 hour as described above) because a loss of consciousness may require a more immediate response than a concussion. In some examples, the second threshold amount of time is 5 seconds, 10 seconds, 30 seconds, 1 minutes, or 5 minutes. For example, if the first threshold amount of time is 1 minute, then the second threshold amount of time is shorter than 1 minute (e.g., 5 seconds, 10 seconds, or 30 seconds). In some examples, the emergency response includes displaying the visual indication 632, shown in FIG. 6C. In some examples, and as described below, the electronic device 101 may automatically initiate communication with the pre-determined contact and/or emergency services.

FIGS. 7A-7E illustrate examples of the second biometric data and the resulting actions on the electronic device. In some examples, after the electronic device 101 (or a second electronic device in communication with the electronic device 101) detects the movement that satisfies the one or more first criteria, as described above, the electronic device 101 captures second biometric data, as described above. For example, the electronic device 101 captures one or more images of the left eye 702 and the right eye 704, shown in FIG. 7A. In some examples, the left eye 702 and the right eye 704 have one or more characteristics of the left eye 602 and the right eye 604, described above. In FIG. 7A, the electronic device 101 captures images that indicate that both eyes are closed. In some examples, the electronic device 101 determines that the eyes are closed when more than 51%, 75%, 80%, 90%, 95%, 99%, or 100% of the eye surface is covered by the eyelid. In some examples, detecting that the eyes are closed after the aforementioned movement is indicative of a loss of consciousness, and therefore the second biometric data satisfies the one or more second criteria. In some examples, the electronic device 101 may also detect a change in blood pressure, heart rate, heart rate variance, breathing, or other changes in biometric data that indicates a loss of consciousness, satisfying the one or more second criteria.

In FIG. 7A, the electronic device 101 detects that the user's eyes (e.g., left eye 702 and/or right eye 704) have been closed for a threshold amount of time (e.g., 5 seconds, 10 seconds, 30 seconds, 1 minute, or 5 minutes). In FIG. 7A, threshold bar 706 indicates that the amount of time that the user's eyes have been closed exceeds the time threshold “t”. After detecting that the user's eyes 702 and/or 704 have been closed for a threshold amount of time, the electronic device 101 initiates an emergency response. In some examples, the emergency response includes initiating communication with an emergency contact (e.g., a predetermined contact, as described above) and/or emergency services (e.g., 911). For example, the electronic device 101 may send a message (e.g., text message, email, voicemail, or other forms of messages) or initiate a call with the emergency contact and/or emergency services.

FIG. 7B illustrates an example of the electronic device 101 displaying an indication 712 in three-dimensional environment 708 that includes text describing that the electronic device 101 has initiated the emergency response. In FIG. 7B, the electronic device 101 includes a display 120 and a plurality of sensors as described above and controlled by the electronic device 101 to capture one or more images of a user or part of a user (e.g., one or more hands of the user) while the user interacts with the electronic device 101 and the physical environment, as described above. The electronic device 101 captures (e.g., using external image sensors 114b and 114c) one or more images of a physical environment 710 around electronic device 101, including one or more objects (e.g., a staircase and a stool) in the physical environment 710 around the electronic device 101. In some examples, the electronic device 101 displays representations of the physical environment 710 in the three-dimensional environment or portions of the physical environment 710 are visible via the display 120 of electronic device 101. For example, three-dimensional environment 708 includes a staircase and a stool that is also in the physical environment 710.

In FIG. 7B, indication 712 includes an option 714 that is selectable to cancel the emergency response (e.g., cancel the phone call, cancel the transmission of the message, or transmit an additional message to indicate that there is no longer an emergency).

In some examples, after detecting the movement that satisfies the one or more first criteria, the electronic device 101 captures one or more media items (e.g., photos, videos, and/or audio) using the one or more input devices, such as external image sensors 114b and 114c, image sensors 206, and/or microphones 216 described above, to determine a location of the event (e.g., the movement that satisfies the one or more first criteria). Additionally, in some examples, the electronic device 101 uses one or more location sensors, such as location sensor(s) 204, described above, to determine a location of the user during/after the movement. For example, and as shown in FIG. 7B, the electronic device 101 detects the movement (e.g., a user falling down the stairs) that satisfies the one or more first criteria and then uses the one or more image sensors and location sensors to gather information about the location of the user.

In some examples, the electronic device 101 uses one or more machine learning and/or artificial intelligence models to summarize the media items captured from the one or more image sensors. In some examples, the electronic device 101 uses machine learning and/or artificial intelligence models such as large learning models to describe the contexts of the media items (e.g., using large language models to determine the events of the media items). In some examples, the electronic device 101 may summarize and/or describe the one or more media items as text to be transmitted in the emergency response to the emergency contact and/or to emergency services. In some examples, the one or more models may take key components of the one or more media items to be transmitted as part of the emergency response. For example, the electronic device 101 may summarize the one or more media items taken from the three-dimensional environment 708 (e.g., the staircase and the position of the electronic device 101 while viewing the staircase), shown in FIG. 7B, to indicate that the user fell down the stairs.

FIG. 7C illustrates an example of a second electronic device 716 receiving and displaying the emergency response transmitted from electronic device 101. In some examples, the second electronic device 716 has one or more characteristics of electronic device 628, shown in FIG. 6C. In FIG. 7C, the electronic device 716 displays an indication 720 corresponding to the emergency response (e.g., the emergency message) sent by the electronic device 101 to the electronic device 716. Indication 720 includes a location of the user and context to describe the movement that occurred. For example, based on the one or the data captured from one or more sensors (e.g., location data and/or media item data) after the movement, the electronic device 101 summarizes, determines, and/or concludes that the user fell down the stairs at a specific location (e.g., “1501 Taft St.”). In some examples, the electronic device 101 may transmit (and the electronic device 716 may display) the one or more media items captured by electronic device 101 after the movement instead of a summary of the one or more media items.

FIG. 7D illustrates an example wherein the electronic device 101 captures second biometric data that does not satisfy the one or more second criteria that is indicative of a loss of consciousness. As shown in FIG. 7D, the electronic device 101 captures that the eyes (e.g., left eye 702 and/or right eye 704) of the user are not closed after detecting the movement that satisfies the one or more first criteria. In some examples, the user does not lose consciousness after the movement. In some examples, the user loses consciousness, but regains consciousness. For example, the user may temporarily lose consciousness but regain consciousness before reaching the threshold amount of time (e.g., the first and/or second threshold amount of time, as described above) wherein the electronic device 101 automatically initiates the emergency response. In some examples, after detecting a movement that satisfies the one or more first criteria and capturing second biometric data that does not satisfy the one or more second criteria, the electronic device 101 increases a rate of capturing additional biometric data, which is described in greater detail above with reference to process 300. For example, and as described above, the electronic device 101 captures additional biometric data (and the second biometric data) at a second time interval greater than the time interval used to capture the first biometric data. The electronic device progressively records the additional biometric data less frequently after a threshold amount of time has passed (e.g., 10 minutes, 30 minutes, or 1 hour) without detecting an abnormality (e.g., an abnormal pupil dilation, as described above). For example, the electronic device records the additional biometric data every 10 seconds. After 30 minutes of recording every 10 seconds without detecting an abnormality has passed, the electronic device begins recording at a greater time interval (e.g., less frequently, such as every 30 seconds, every minute, every 30 minutes, or every hour). In some examples, after a threshold amount of time has passed, the electronic device slowly begins increasing the time interval until the time interval is the same as the time interval used to record the first biometric data, as described above.

FIG. 7E illustrates electronic device 101 displaying three-dimensional environment 708 after user regains consciousness. In some examples, after detecting that the user regains consciousness (e.g., the one or more eyes are open after being previously closed after the movement), the user may cancel the emergency response. In some examples, the electronic device 101 receives an input including gaze 722a (e.g., alternatively, the input may include a contact such as a finger, mouse, stylus, or an indirect contact such as an air-pinch or air-tap) directed towards option 714 to cancel the emergency response. Alternatively, or additionally, in some examples, the electronic device 101 receives an input including gaze 722b directed towards a corner of the display 120, which corresponds to a request to cancel the emergency response. In some examples, the user may gaze at any corner of the display 120 to cancel the emergency response. In some examples, the user may preprogram a gaze towards one or more corners of the display 120 to correspond to a specific action (e.g., canceling a current action, activating a voice assistant, returning to a previous user interface, opening a user interface of a specified application, or other actions). In response to receiving the input to cancel the emergency response, the electronic device 101 may hang up the phone call, forgo transmitting the message, or transmit an additional message indicating that there is no longer an emergency.

In some examples, if the second biometric data or the additional biometric data includes data that is indicative of a concussion (e.g., abnormal pupil dilation), as described above and with reference to process 300, then the electronic device 101 displays a visual indication, such as indication 622 as shown in FIG. 6C, which includes a selectable option to notify a contact of the user of the abnormality.

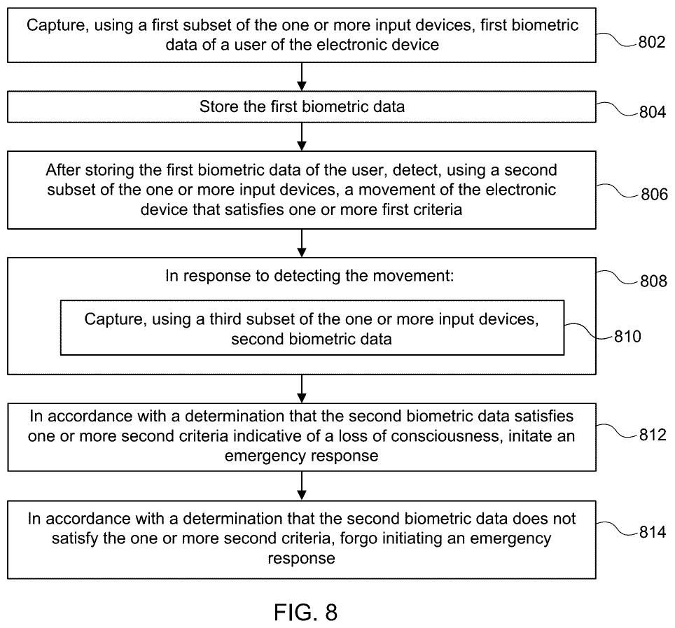

FIG. 8 illustrates a flow chart of an example process of an electronic device recording biometric data and initiating an emergency response in response to detecting a movement of the electronic device according to some examples of the disclosure. FIGS. 4A-4B, 5A-5B, 6A-6C, and 7A-7E are used to illustrate the processes described below, including process 800 in FIG. 8.

In some examples, process 800 begins at an electronic device in communication with one or more displays and one or more input devices. In some examples, the electronic device, one or more displays, and one or more input devices has one or more characteristics of the electronic device, one or more displays, and one or more input devices described in process 300. In some examples, the electronic device captures (802), using a first subset of the one or more input devices, first biometric data of a user of the electronic device, such as the first biometric data described in greater detail in process 300 and shown in FIGS. 4A-4B. For example, the first biometric data includes data relating to pupil dilation of each eye of the user. In some examples, the first biometric data includes data relating to the area of the user eye(s) that are exposed when the user(s) eyes are open. Additionally, in some examples, the first biometric data includes other data relating to a user's health, as described in process 300. In some examples, one or more portions of the first biometric data may be recorded/collected by a second electronic device in communication with the electronic device, such as electronic device 628 shown in FIG. 6C, or electronic device 716, shown in FIG. 7C. In some examples, the second electronic device may be a smart watch, smart ring, pedometer, tablet or other devices that may be used to gather biometric data.

In some examples, the electronic device stores (804) the first biometric data, as described in greater detail in process 300. In some examples, the electronic device stores the first biometric data including data received from a second electronic device on the electronic device. In some examples, the first biometric data serves as a baseline for the user and is used to determine whether a different set of biometric data is abnormal relative to the first biometric data.

In some examples, after storing the first biometric data of the user, the electronic device detects (806), using a second subset of the one or more input devices, a movement of the electronic device that satisfies one or more first criteria, as described in greater detail in process 300. In some examples, the second subset of the one or more input devices includes motion sensors, such as orientation sensor(s) 210, location sensor(s) 204, and/or image sensor(s) 206. In some examples, the one or more first criteria is satisfied when the movement exceeds a threshold acceleration, a rapid change in acceleration is identified (e.g., greater than 1 m/s², 5 m/s², or 10 m/s²), a rapid change in the portion of the physical environment that is included in the three-dimensional environment (e.g., the user was looking at trees and is suddenly looking at the sky), and/or a combination of the above are identified. For example, a car accident, a fall (e.g., down stairs, out of a swing, or other falls), a slip, a bike accident, a ski accident, or other impacts may cause a movement that satisfies one or more first criteria. For example, and as shown in FIG. 7B, the user falls down the stairs and a sudden change in acceleration was detected.

In some examples, in response to detecting the movement (808), the electronic device captures (810), using a third subset of the one or more input devices, second biometric data, as described in greater detail in process 300. In some examples, the third subset of the one or more input devices is the same subset as the first subset of the one or more input devices described in step 302a of process 300. In some examples, the second biometric data includes data about the user's eyes and health (e.g., (e.g., pupil dilation, pupil movement, sleep, and other data discussed above).

In some examples, in accordance with a determination that the second biometric data satisfies one or more second criteria indicative of a loss of consciousness, the electronic device initiates (812) an emergency response, such as the response shown by indication 720 in FIG. 7C. In some examples, the emergency response includes initiating communication (e.g., a phone call, email, text message, or other forms of communication) with a contact (e.g., predetermined contact) of the user and/or with emergency services. In some examples, the electronic device uses the one or more input devices to capture one or more media items (e.g., images, videos, and/or audio recordings) of the user's environment where the movement that satisfies the one or more first criteria occurred. In some examples, the electronic device summarizes the one or more media items as text and/or audio to be transmitted in the emergency response to the respective contact and/or emergency services. In some examples, the one or more media items and/or the summary provides context and information for the respective contact and/or emergency services such as what the movement was (e.g., falling down the stairs, car accident, or other movements), if there are other people around to help, and other contextual information.

In some examples, in accordance with a determination that the second biometric data does not satisfy the one or more second criteria, the electronic device forgoes initiating (814) an emergency response, such as shown by eyes 702 and 704 in FIG. 7D. In some examples, the second biometric data does not satisfy the one or more second criteria when the second biometric data does not indicate a loss of consciousness. In some examples, the second biometric data may indicate a loss of consciousness but then the user regains consciousness and the second biometric data no longer satisfies the one or more second criteria. In some examples, while the second biometric data does not indication a loss of consciousness, the second biometric data may indicate other abnormalities (e.g., a concussion) and the electronic device 101 performs one or more steps based on the abnormalities in accordance with process 300. For example, if the second biometric data indicates abnormalities, the electronic device 101 displays a visual indication, such as indication 622 as shown in FIG. 6C, which includes a selectable option to notify a contact of the user of the abnormality. In some examples, if the user regains consciousness after the electronic device 101 initiates the emergency response, the user may cancel the emergency response. In some examples, in FIG. 7E, the electronic device 101 receives an input to cancel the emergency response. In some examples, if the second biometric data satisfies the one or more second criteria, the electronic device 101 initiates the emergency response after a first threshold amount of time (e.g., 1 second, 5 seconds, 10 seconds, 30 seconds, 1 minute, or 5 minutes). In some examples, if the second biometric data does not satisfy the one or more second criteria, the electronic device 101 initiates the emergency response after a second threshold amount of time (e.g., 5 seconds, 10 seconds, 30 seconds, 1 minute, 5 minutes, or 10 minutes), longer than the first threshold.

It is understood that process 800 is an example and that more, fewer, or different operations can be performed in the same or in a different order. Additionally, the operations in process 300 described above are, optionally, implemented by running one or more functional modules in an information processing apparatus such as general-purpose processors (e.g., as described with respect to FIG. 2) or application specific chips, and/or by other components of FIG. 2.

Therefore, according to the above, some examples of the disclosure are directed to a method, comprising: at an electronic device in communication with one or more displays and one or more input devices: capturing, using a first subset of the one or more input devices, first biometric data of a user of the electronic device, storing the first biometric data, after storing the first biometric data of the user, detecting, using a second subset of the one or more input devices, a movement of the electronic device that satisfies one or more first criteria, in response to detecting the movement: capturing, using a third subset of the one or more input devices, second biometric data, in accordance with a determination that the second biometric data satisfies one or more second criteria including a criterion that is satisfied based on a comparison of the second biometric data with the first biometric data, displaying a visual indication, and in accordance with a determination that the second biometric data does not satisfy the one or more second criteria, forgoing displaying the visual indication. Additionally or alternatively to one of more of the examples disclosed above, in some examples, the first biometric data includes a first pupil dilation of each eye of the user. Additionally or alternatively to one of more of the examples disclosed above, in some examples, the first biometric data is stored as a first pupil dilation baseline of each eye of the user. Additionally or alternatively to one of more of the examples disclosed above, in some examples, the first subset of the one or more input devices includes the same subset of the one or more input devices as the third subset of the one or more input devices. Additionally or alternatively to one of more of the examples disclosed above, in some examples, the second biometric data includes a second pupil dilation of each eye of the user. Additionally or alternatively to one of more of the examples disclosed above, in some examples, the one or more first criteria include a criterion that is satisfied when the movement of the electronic device is indicative of a head of the user exceeding a threshold acceleration. Additionally or alternatively to one of more of the examples disclosed above, in some examples, the second subset of the one or more input devices includes an accelerometer. Additionally or alternatively to one of more of the examples disclosed above, in some examples, the method further includes detecting the movement of the electronic device further comprises detecting, using a sensor on a second electronic device, a sudden change in acceleration. Additionally or alternatively to one of more of the examples disclosed above, in some examples, the method further includes transmitting an indication of the first biometric data to be processed by an application on the electronic device. Additionally or alternatively to one of more of the examples disclosed above, in some examples, the method further includes capturing the second biometric data includes capturing the second biometric data using sensors at progressive time interval after detecting the movement of the electronic device. Additionally or alternatively to one of more of the examples disclosed above, in some examples, the first biometric data includes walking asymmetry, sleep time, and nausea. Additionally or alternatively to one of more of the examples disclosed above, in some examples, the method further includes in accordance with the determination that the second biometric data satisfies the one or more second criteria, decreasing a rate of capturing additional biometric data. Additionally or alternatively to one of more of the examples disclosed above, in some examples, the visual indication includes a selectable option to notify a contact of the user. Additionally or alternatively to one of more of the examples disclosed above, in some examples, the one or more input devices capture other data in conjunction with the first biometric data. Additionally or alternatively to one of more of the examples disclosed above, in some examples, the comparison of the second biometric data with the first biometric data includes an environmental context factor.

Some examples of the disclosure are directed towards a method comprising: at an electronic device in communication with one or more displays and one or more input devices: capturing, using a first subset of the one or more input devices, first biometric data of a user of the electronic device; storing the first biometric data; after storing the first biometric data of the user, detecting, using a second subset of the one or more input devices, a movement of the electronic device that satisfies one or more first criteria; in response to detecting the movement: capturing, using a third subset of the one or more input devices, second biometric data; in accordance with a determination that the second biometric data satisfies one or more second criteria indicative of a loss of consciousness, initiating an emergency response; and in accordance with a determination that the second biometric data does not satisfy the one or more second criteria, forgoing initiating an the emergency response. Additionally or alternatively to one of more of the examples disclosed above, in some examples the method includes detecting, via the one or more input devices, one or more images of one or more eyes of the user indicative of the loss of consciousness. Additionally or alternatively to one of more of the examples disclosed above, in some examples the one or more images of one or more eyes includes one or more images of one or more eyes being closed for a threshold amount of time. Additionally or alternatively to one of more of the examples disclosed above, in some examples the method includes in response to detecting that the second biometric data does not satisfy the one or more second criteria, increasing a rate of capturing additional biometric data. Additionally or alternatively to one of more of the examples disclosed above, in some examples initiating the emergency response includes initiating communication with a contact of a user. Additionally or alternatively to one of more of the examples disclosed above, in some examples initiating the emergency response includes initiating communication with emergency services. Additionally or alternatively to one of more of the examples disclosed above, in some examples initiating the emergency response includes transmitting an indication of a location of the user. Additionally or alternatively to one of more of the examples disclosed above, in some examples transmitting the indication of the location of the user further includes: capturing, using a fourth subset of the one or more input devices including a camera, one or more media items; and summarizing contents of the one or more media items as the indication of the location of the user. Additionally or alternatively to one of more of the examples disclosed above, in some examples the method includes summarizing the contents of the one or more media items as an indication of the movement. Additionally or alternatively to one of more of the examples disclosed above, in some examples the method includes after initiating the emergency response, capturing, using a fourth subset of the one or more input devices, third biometric data including an indication of consciousness; in response to capturing the third biometric data, displaying, via the one or more displays, one or more selectable options to cease the emergency response. Additionally or alternatively to one of more of the examples disclosed above, in some examples the method includes while displaying the one or more selectable options to cease initiation of the emergency response, receiving, via the one or more input devices, an input including a gaze directed towards the one or more selectable options; and in response to receiving the input including the gaze, ceasing the emergency response. Additionally or alternatively to one of more of the examples disclosed above, in some examples in response to detecting the movement, the method further comprises: capturing, using a location sensor, location data of the user. Additionally or alternatively to one of more of the examples disclosed above, in some examples detecting the movement of the electronic device further comprises detecting, using a sensor on a second electronic device, an acceleration that exceeds a threshold acceleration. Additionally or alternatively to one of more of the examples disclosed above, in some examples in response to detecting the movement of the electronic device, the method further comprises: in accordance with a determination that the second biometric data satisfies one or more third criteria indicative of a concussion, displaying, via the one or more displays, a visual indication. Additionally or alternatively to one of more of the examples disclosed above, in some examples the method includes the visual indication includes a selectable option to notify a contact of the user. Additionally or alternatively to one of more of the examples disclosed above, in some examples initiating the emergency response after determining that the second biometric data satisfies the one or more second criteria include initiating the emergency response after a first time threshold; and the method further comprises: initiating the emergency response after determining that the second biometric data does not satisfies the one or more second criteria after a second time threshold, wherein the second time threshold is longer than the first time threshold.

Some examples of the disclosure are directed to an electronic device, comprising: one or more processors; memory; and one or more programs stored in the memory and configured to be executed by the one or more processors, the one or more programs including instructions for performing any of the above methods.

Some examples of the disclosure are directed to a non-transitory computer readable storage medium storing one or more programs, the one or more programs comprising instructions, which when executed by one or more processors of an electronic device, cause the electronic device to perform any of the above methods.

Some examples of the disclosure are directed to an electronic device, comprising one or more processors, memory, and means for performing any of the above methods.

Some examples of the disclosure are directed to an information processing apparatus for use in an electronic device, the information processing apparatus comprising means for performing any of the above methods.

The present disclosure contemplates that in some instances, the data utilized may include personal information data that uniquely identifies or can be used to contact or locate a specific person. Such personal information data can include demographic data, content consumption activity, location-based data, telephone numbers, email addresses, twitter ID's, home addresses, data or records relating to a user's health or level of fitness (e.g., vital signs measurements, medication information, exercise information), date of birth, or any other identifying or personal information. Specifically, as described herein, one aspect of the present disclosure is tracking a user's biometric data.

The present disclosure recognizes that the use of such personal information data, in the present technology, can be used to the benefit of users. For example, personal information data may be used to display a visual indication based on changes in a user's biometric data. For example, the visual indication includes a recommendation for the user to visit or contact a health professional as a result of the detecting an abnormality compared with baseline biometric data.

The present disclosure contemplates that the entities responsible for the collection, analysis, disclosure, transfer, storage, or other use of such personal information data will comply with well-established privacy policies and/or privacy practices. In particular, such entities should implement and consistently use privacy policies and practices that are generally recognized as meeting or exceeding industry or governmental requirements for maintaining personal information data private and secure. Such policies should be easily accessible by users, and should be updated as the collection and/or use of data changes. Personal information from users should be collected for legitimate and reasonable uses of the entity and not shared or sold outside of those legitimate uses. Further, such collection/sharing should occur after receiving the informed consent of the users. Additionally, such entities should consider taking any needed steps for safeguarding and securing access to such personal information data and ensuring that others with access to the personal information data adhere to their privacy policies and procedures. Further, such entities can subject themselves to evaluation by third parties to certify their adherence to widely accepted privacy policies and practices. In addition, policies and practices should be adapted for the particular types of personal information data being collected and/or accessed and adapted to applicable laws and standards, including jurisdiction-specific considerations. For instance, in the US, collection of or access to certain health data may be governed by federal and/or state laws, such as the Health Insurance Portability and Accountability Act (HIPAA); whereas health data in other countries may be subject to other regulations and policies and should be handled accordingly. Hence different privacy practices should be maintained for different personal data types in each country.

Despite the foregoing, the present disclosure also contemplates examples in which users selectively block the use of, or access to, personal information data. That is, the present disclosure contemplates that hardware and/or software elements can be provided to prevent or block access to such personal information data. For example, the present technology can be configured to allow users to select to “opt in” or “opt out” of participation in the collection of personal information data during registration for services or anytime thereafter. In another example, users can select not to enable recording of personal information data in a specific application (e.g., first application and/or second application). In addition to providing “opt in” and “opt out” options, the present disclosure contemplates providing notifications relating to the access or use of personal information. For instance, a user may be notified upon initiating collection that their personal information data will be accessed and then reminded again just before personal information data is accessed by the device(s).

Moreover, it is the intent of the present disclosure that personal information data should be managed and handled in a way to minimize risks of unintentional or unauthorized access or use. Risk can be minimized by limiting the collection of data and deleting data once it is no longer needed. In addition, and when applicable, including in certain health related applications, data de-identification can be used to protect a user's privacy. De-identification may be facilitated, when appropriate, by removing specific identifiers (e.g., date of birth, etc.), controlling the amount or specificity of data stored (e.g., collecting location data a city level rather than at an address level), controlling how data is stored (e.g., aggregating data across users), and/or other methods.

The foregoing description, for purpose of explanation, has been described with reference to specific examples. However, the illustrative discussions above are not intended to be exhaustive or to limit the disclosure to the precise forms disclosed. Many modifications and variations are possible in view of the above teachings. The examples were chosen and described in order to best explain the principles of the disclosure and its practical applications, to thereby enable others skilled in the art to best use the disclosure and various described examples with various modifications as are suited to the particular use contemplated.

1. A method comprising:
at an electronic device in communication with one or more displays and one or more input devices:
capturing, using a first subset of the one or more input devices, first biometric data of a user of the electronic device;
storing the first biometric data;
after storing the first biometric data of the user, detecting, using a second subset of the one or more input devices, a movement of the electronic device that satisfies one or more first criteria;
in response to detecting the movement:
capturing, using a third subset of the one or more input devices, second biometric data;
in accordance with a determination that the second biometric data satisfies one or more second criteria including a criterion that is satisfied based on a comparison of the second biometric data with the first biometric data, displaying a visual indication; and
in accordance with a determination that the second biometric data does not satisfy the one or more second criteria, forgoing displaying the visual indication.

2. The method of claim 1, wherein the first biometric data includes a first pupil dilation of each eye of the user and the second biometric data includes a second pupil dilation of one or more eyes of the user.

3. The method of claim 2, wherein the first biometric data is stored as a first pupil dilation baseline of one or more eyes of the user.

4. The method of claim 1, wherein the one or more first criteria include a criterion that is satisfied when the movement of the electronic device is indicative of a head of the user exceeding a threshold acceleration.

5. The method of claim 1, wherein detecting the movement of the electronic device further comprises detecting, using a sensor on a second electronic device, an acceleration that exceeds a threshold acceleration.

6. The method of claim 1, wherein capturing the second biometric data includes capturing the second biometric data using sensors at progressive time intervals after detecting the movement of the electronic device.

7. The method of claim 1, wherein in response to detecting the movement of the electronic device, the method further comprises:
in accordance with a determination that the second biometric data satisfies one or more third criteria indicative of a loss of consciousness, initiating an emergency response.

8. The method of claim 1, wherein in accordance with the determination that the second biometric data satisfies the one or more second criteria, decreasing a rate of capturing additional biometric data.

9. An electronic device comprising:
one or more displays;
one or more input devices;
a memory;
one or more processors; and
one or more programs stored in the memory and configured to be executed by the one or more processors, the one or more programs including instructions for:
capturing, using a first subset of the one or more input devices, first biometric data of a user of the electronic device;
storing the first biometric data;
after storing the first biometric data of the user, detecting, using a second subset of the one or more input devices, a movement of the electronic device that satisfies one or more first criteria;
in response to detecting the movement:
capturing, using a third subset of the one or more input devices, second biometric data;
in accordance with a determination that the second biometric data satisfies one or more second criteria including a criterion that is satisfied based on a comparison of the second biometric data with the first biometric data, displaying a visual indication; and
in accordance with a determination that the second biometric data does not satisfy the one or more second criteria, forgoing displaying the visual indication.

10. The electronic device of claim 9, wherein the first biometric data includes a first pupil dilation of each eye of the user and the second biometric data includes a second pupil dilation of one or more eye of the user.

11. The electronic device of claim 10, wherein the first biometric data is stored as a first pupil dilation baseline of one or more eye of the user.

12. The electronic device of claim 9, wherein the one or more first criteria include a criterion that is satisfied when the movement of the electronic device is indicative of a head of the user exceeding a threshold acceleration.

13. The electronic device of claim 9, wherein detecting the movement of the electronic device further comprises detecting, using a sensor on a second electronic device, an acceleration that exceeds a threshold acceleration.

14. The electronic device of claim 9, wherein capturing the second biometric data includes capturing the second biometric data using sensors at progressive time intervals after detecting the movement of the electronic device.

15. The electronic device of claim 9, wherein in response to detecting the movement of the electronic device:
in accordance with a determination that the second biometric data satisfies one or more third criteria indicative of a loss of consciousness, initiating an emergency response.

16. The electronic device of claim 9, wherein in accordance with the determination that the second biometric data satisfies the one or more second criteria, decreasing a rate of capturing additional biometric data.

17. A non-transitory computer readable storage medium storing one or more programs, the one or more programs comprising instructions, which when executed by one or more processors of an electronic device, cause the electronic device to perform a method comprising:
capturing, using a first subset of one or more input devices, first biometric data of a user of the electronic device;
storing the first biometric data;
after storing the first biometric data of the user, detecting, using a second subset of the one or more input devices, a movement of the electronic device that satisfies one or more first criteria;
in response to detecting the movement:
capturing, using a third subset of the one or more input devices, second biometric data;
in accordance with a determination that the second biometric data satisfies one or more second criteria including a criterion that is satisfied based on a comparison of the second biometric data with the first biometric data, displaying a visual indication; and
in accordance with a determination that the second biometric data does not satisfy the one or more second criteria, forgoing displaying the visual indication.

18. The non-transitory computer readable storage medium of claim 17, wherein the first biometric data includes a first pupil dilation of each eye of the user and the second biometric data includes a second pupil dilation of one or more eye of the user.

19. The non-transitory computer readable storage medium of claim 18, wherein the first biometric data is stored as a first pupil dilation baseline of one or more eye of the user.

20. The non-transitory computer readable storage medium of claim 17, wherein the one or more first criteria include a criterion that is satisfied when the movement of the electronic device is indicative of a head of the user exceeding a threshold acceleration.

21. The non-transitory computer readable storage medium of claim 17, wherein detecting the movement of the electronic device further comprises detecting, using a sensor on a second electronic device, an acceleration that exceeds a threshold acceleration.

22. The non-transitory computer readable storage medium of claim 17, wherein capturing the second biometric data includes capturing the second biometric data using sensors at progressive time intervals after detecting the movement of the electronic device.

23. The non-transitory computer readable storage medium of claim 17, wherein in response to detecting the movement of the electronic device:
in accordance with a determination that the second biometric data satisfies one or more third criteria indicative of a loss of consciousness, initiating an emergency response.

24. The non-transitory computer readable storage medium of claim 17, wherein in accordance with the determination that the second biometric data satisfies the one or more second criteria, decreasing a rate of capturing additional biometric data.
